(19) United States
(12) Patent Application Publication
(10) Pub. No.: US 2010/0082584 A1
(43) Pub. Date: Apr. 1, 2010

(54) SYSTEM, DEVICE AND METHOD FOR INQUIRING POSITION INFORMATION

(75) Inventor: Chien-Hung Cheng, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/256,440

(22) Filed: Oct. 22, 2008

(30) Foreign Application Priority Data
Sep. 26, 2008 (CN) 200810304693.8

(51) Int. Cl. G06F 17/30; G01C 21/00

(52) U.S. Cl. 707/706; 701/213

(57) ABSTRACT

A computing system and method for inquiring position information are provided. The system includes a push database and a portable electronic device for transmitting a query message including a keyword regarding a navigation destination to the push database. The push database conducts a search with the query message to obtain at least one search item and transmits the at least one search item to the portable electronic device. The at least one search item includes a detail address and a corresponding global positioning system (GPS) coordinate value of a specific position. The portable electronic device conducts navigation using the corresponding GPS coordinate value in response to a user selection of the at least one search item.

### BACKGROUND

1. Field of the Invention

Embodiments of the present disclosure relate to position information, and more particularly to a system, device and method for inquiring position information by a portable electronic device.

2. Description of Related Art

Navigational systems, such as the Global Positioning Systems (GPS) are gaining popularity with the public. Generally, GPS works by utilizing a cluster of satellites to determine a receiver's location. For example, each satellite in the cluster broadcasts a signal with identification, time and location information. A receiver receives this information from a plurality of satellites to determine the receiver's position.

On the other hand, cellular phones are becoming an indispensable tool for many users, so indispensable that they are carried with the user wherever the user goes. Accordingly, the cellular phones provided with GPS navigation function are developed so that users may use position information for vehicle navigation and/or route tracking. However, users have to obtain a detail address of a navigation destination and then input the detail addresses to the cellular phone so as to conduct the navigation, and thus causing inconvenience.

Accordingly, a system, device and method for inquiring position information are desirable in order to overcome the limitations described.

### SUMMARY

A computing system for inquiring position information is provided. The system includes a portable electronic device and a push database. The portable electronic device transmits a query message including a keyword regarding a navigation destination. The push database conducts a search with the query message to obtain at least one search item and transmits the at least one search item to the portable electronic device. The at least one search item includes a detail address and a corresponding global positioning system (GPS) coordinate value of a specific position. The portable electronic device conducts navigation using the corresponding GPS coordinate value in response to a user selection of the at least one search item.

Other advantages and novel features of the system, device and method for inquiring position information will become more apparent from the following detailed description of certain inventive embodiments when taken in conjunction with the accompanying drawings.

### BRIEF DESCRIPTION OF THE DRAWINGS

FIG. 1 is a system view of an embodiment of a system for inquiring position information;

FIG. 2 is a schematic block diagram of a portable electronic device of FIG. 1; and

FIG. 3 is a flowchart of an embodiment of a method for inquiring position information.

### DETAILED DESCRIPTION OF CERTAIN INVENTIVE EMBODIMENTS

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication device.

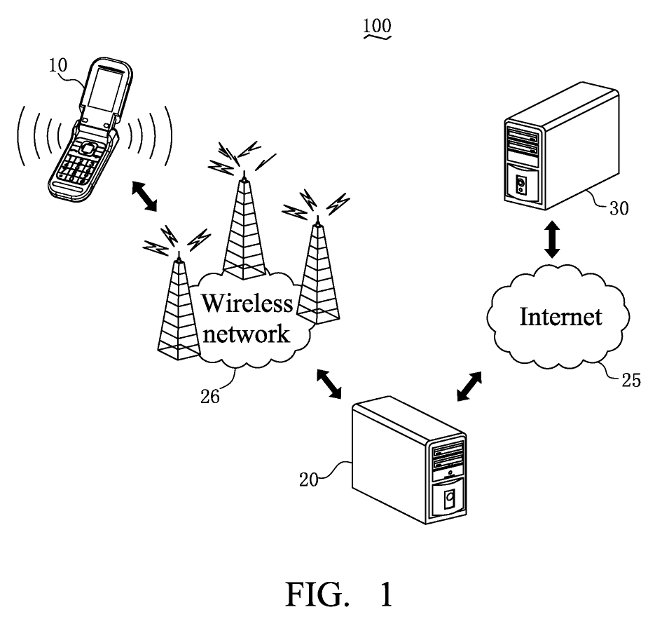

FIG. 1 is a system view of an embodiment of a system 100 for inquiring position information of a portable electronic device 10 The system 100 includes the portable electronic device 10, a push proxy gateway 20, and a push database 30. In the illustrated embodiment, the portable electronic device 10 is a mobile phone, although other electronic devices, such as notebook computers, and personal digital assistants (PDAs), for example, are equally applicable while fully maintaining the scope of the disclosure.

The portable electronic device 10 connects to the user terminals 20 by a Push Over-Over-the-Air (Push OTA) Protocol located over a Wireless Session Protocol (WSP). The push proxy gateway 20 is an entry point between the Internet 25 and a wireless network 26. The push proxy gateway 20 connects to the Internet 25 by the Push Access Protocol (PAP), and then connects to the push database 30.

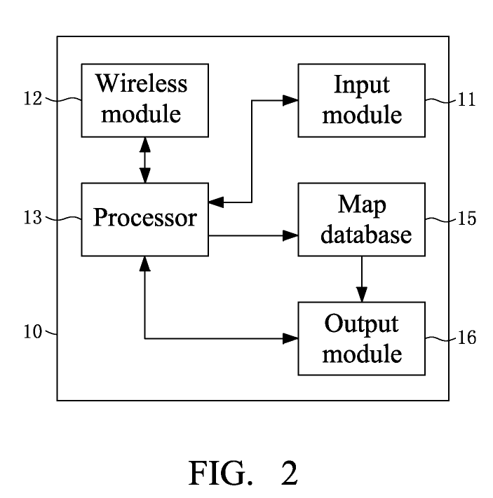

FIG. 2 is a schematic block diagram of the portable electronic device 10 of FIG. 1. In one embodiment, the portable electronic device 10 includes an input module 11, a wireless module 12, a processor 13, a map database 15 and a output module 16.

The input module 11 is configured for inputting a keyword regarding a navigation destination. The wireless module 12 is configured for establishing connections between the portable electronic device 10 and the push database 30. The map database 15 is configured for transmitting corresponding map information basing on an inputted GPS coordinate value to the output module 16. The processor 13 is configured for executing the input module 11, the wireless module 12, the map database 15, and the output module 16.

When conducting the navigation by the portable electronic device 10, a keyword regarding the navigation destination is inputted to the input module 11. The processor 13 then encodes the keyword to be a query message, and establishes a network connection between the portable electronic device 10 and the push proxy gateway 20 by the wireless module 12 for transmitting the query message.

Upon receipt of the query message from the portable electronic device 10, the push proxy gateway 20 forwards the query message to the push database 30 by a Hyper Text Transfer Protocol (HTTP) GET request. The push database 30 then conducts search with the query message and saves the search results as at least one search item. It is to be noted that the at least one search item includes a detail address and the corresponding GPS coordinate value of a specific location.

The push database 30 transmits the at least one search item to the push proxy gateway 20 by an HTTP RESPONSE. The at least one search item may be encoded in a Wireless Markup Language (WML) and is in a text format. The push proxy gateway 20 then transmits the at least one search item to the portable electronic device 10 by the Push OTA protocol.

Upon receipt of the at least one search item from the push proxy gateway 20, the at least one search item is transmitted from the wireless module 12 to the output module 16 for displaying the at least one search item. End users then select one search item dependent on the detail address thereof. In response to a user selection of the at least one search item, the processor 13 transmits the corresponding GPS coordinate value of the selected search item to the map database 15 for displaying the map information by the output module 16.

Understandably, in alternative embodiments, the functions performed by the push proxy gateway 20 and push database 30 may be incorporated to be performed by a single server.

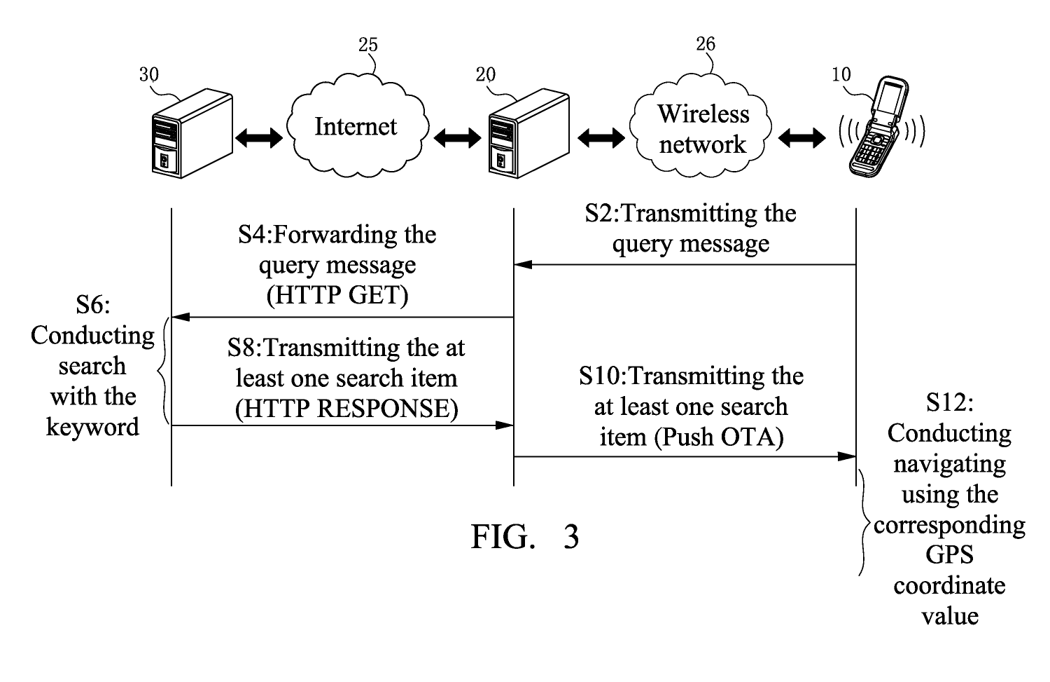

FIG. 3 is a flowchart of an embodiment of a method for inquiring position information for the system 100. The method of FIG. 3 may be used to obtain at least one search item, including detail addresses and the corresponding GPS coordinate values of a specific location, regarding the navigation destination. Depending on the embodiment, additional blocks may be added or deleted and the blocks may be executed in order other than that described.

In block S2, the portable electronic device 10 transmits the query message including the keyword regarding the navigation destination. Upon receipt of the query message, in block S4, the push proxy gateway 20 forwards the query message by the HTTP GET request. In block S6, the push database 30 conducts search with the keyword so as to obtain at least one search item. As described above, the at least one search item includes the detail address and the GPS coordinate value of the specific location.

In block S8, the push database 30 transmits the at least one search item to the push proxy gateway 20 by an HTTP RESPONSE. In block S10, the push proxy gateway 20 transmits the at least one search item to the portable electronic device 10 by the Push OTA.

Upon receipt of the at least one search item, one of the at least one search item is selected according to the detail address of the at least one search item. Then, in block S12, the GPS coordinate value of the selected search item is utilized to conduct the navigation.

It should be emphasized that the described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A computing system for inquiring position information, the system comprising:
a portable electronic device for transmitting a query message comprising a keyword regarding a navigation destination;
a push database for conducting a search with the query message to obtain at least one search item and transmitting the at least one search item to the portable electronic device, wherein the at least one search item comprising a detail address and a corresponding global positioning system (GPS) coordinate value of a specific position; and
the portable electronic device conducts navigation using the corresponding GPS coordinate value in response to a user selection of the at least one search item.

2. The system as claimed in claim 1, wherein the portable electronic device further comprises an output module and a map database for transmitting a corresponding map of the GPS coordinate value of the selected search item to the output module.

3. The system as claimed in claim 2, wherein the output module is configured for displaying the corresponding map.

4. The system as claimed in claim 1, wherein the system further comprises a push proxy server for receiving the query message from the portable electronic device by a push over-the-air protocol, and for forwarding the query message to the push database by a push access protocol.

5. The system as claimed in claim 4, wherein the portable electronic device further comprises a wireless module for connecting to the push proxy gateway and the push database.

6. The system as claimed in claim 1, wherein the at least one search item is encoded in a wireless markup language.

7. The system as claimed in claim 1, wherein the portable electronic device further comprises an input module for inputting the keyword.

8. A portable electronic device for inquiring position information, the device comprising:
an input module for inputting a keyword regarding a navigation destination;
a wireless module for establishing a connection between the portable electronic device and a push database;
a processor for encoding the keyword to be a query message, transmitting the query message to the push database to obtain at least one search item comprising a detail address and a corresponding GPS coordinate value of a specific position;
an output module; and
a map database for transmitting a corresponding map information based on an inputted GPS coordinate value to the output module in response to a user selection of the at least one search item so as to displays the map information by the output module.

9. The device as claimed in claim 8, wherein the wireless module connects to a push proxy gateway for transmitting the query message by a push over-the-air protocol, and the push proxy gateway forwards the query message to the push database.

10. The device as claimed in claim 8, wherein at least one search item is obtained by searching the push database with the keyword.

11. The device as claimed in claim 8, wherein the at least one search item is encoded in a wireless markup language.

12. A computer-implemented method for inquiring position information, the method comprising:
transmitting a query message comprising a keyword regarding a navigation destination to a push database;
receiving at least one search item obtained by searching the push database with the keyword, and the at least one search item comprising a detail address and a corresponding GPS coordinate value of a specific position; and
conducting navigation in response to a user selection of the at least one search item.

13. The method as claimed in claim 12, wherein after transmitting the query message, the method further comprises:
establishing a connection with a push proxy gateway by a push over-the-air protocol; and
transmitting the query message to the push database by a push access protocol.

14. The method as claimed in claim 12, wherein the keyword is inputted by an input module and encoded to be the query message.

15. The method as claimed in claim 12, wherein the at least one search item is encoded in a wireless markup language.

16. The method as claimed in claim 12, wherein after conducting the navigation, the method further comprises:
transmitting corresponding map information stored in a map database to an output module basing on an inputted GPS coordinate value of the selected search item; and
displaying the map information by the output module.
